(19) United States
(12) Patent Application Publication
(10) Pub. No.: US 2010/0027540 A1
(43) Pub. Date: Feb. 4, 2010

(54) CAPTURE APPARATUS AND CAPTURE METHOD

(75) Inventor: Masakazu Sato, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/576,041

(22) Filed: Oct. 8, 2009

Related U.S. Application Data
(63) Continuation of application No. PCT/JP2007/058141, filed on Apr. 13, 2007.

(51) Int. Cl. H04L 12/56

(52) U.S. Cl. 370/389

(57) ABSTRACT

A capture apparatus that connected with communication path and captures communication data passing through the communication path and stores the communication data in a storage medium. The capture apparatus is provided with a retrieval condition retaining section 5 and a retained data management section 6 that retain at least one set of position information of an area set to the storage medium and the condition of the communication data stored in the area, a retrieval execution section 4 that captures communication data matched with the condition retained by the retrieval condition retaining section 5 out of the communication data passing through the communication path, and a retained data management section 6 and a data retaining section 7 that capture the position information of the storage area which is an area corresponding to the condition matched with the matching data and store the matching data in the storage area.

### CROSS-REFERENCE TO RELATED APPLICATIONS

This application is a continuation application, filed under 35 U.S.C. §111(a), of PCT Application No. PCT/JP2007/058141, filed Apr. 13, 2007, the disclosure of which is herein incorporated in its entirety by reference.

### FIELD

The present invention relates to a capture apparatus and a capture method that perform packet capture.

### BACKGROUND

With recent growing awareness of security issues, there is an increase demand that communication data be retained for detection of network abnormality and analysis of the abnormality.

In such a situation, there is also an increasing demand that a network relay apparatus (hereinafter referred to merely as “relay apparatus”) be used to recognize specific communication data and temporarily retain it and a management apparatus provided outside the relay apparatus be used to analyze the communication data.

As a method for retaining communication data flowing in the relay apparatus, there is generally known a method in which an external capture apparatus such as a RMON (Remote Network Monitoring) probe or LAN analyzer is provided outside the relay apparatus.

The external capture apparatus is provided between a network and a relay apparatus connected to the network so as to retrieve data flowing in the network and retain the retrieved data. The data captured by the external capture apparatus is then analyzed in the external capture apparatus itself or uploaded to an apparatus called a management apparatus provided outside the external capture apparatus to be browsed, stored, and analyzed.

Recently, there has appeared a relay apparatus that incorporates therein a function equivalent to that of the external capture apparatus. Such a relay apparatus captures data flowing therein and uploads all the captured data to a management apparatus. Further, such a relay apparatus needs to be analyzed after the external management apparatus re-retrieves really-required data.

As a prior art relating to the present invention, the following technique is known.

### [Patent Document 1] Japanese Laid-open Patent Publication No. 2001-069173

### SUMMARY

According to an aspect of the present invention, there is provided a capture apparatus that can be connected to at least one communication path and captures communication data passing through the communication path and stores it in a storage medium, including: a retaining section that retains at least one set of position information of an area set to the storage medium and the condition of the communication data stored in the area; an acquisition section that captures communication data matched with the condition retained by the retaining section out of the communication data passing through the communication path as matching data; and a storage section that captures the position information of the storage area which is an area corresponding to the condition matched with the matching data and stores at least the matching data in the storage area.

According to another aspect of the present invention, there is provided a capture apparatus that can be connected to at least one communication path and captures communication data passing through the communication path and stores it in a storage medium, including: an acquisition section that captures communication data matched with set condition out of the communication data passing through the communication path as matching data; a storage section that stores the matching data in an area set to the storage medium; a discard section that performs, when the storage section stores the matching data in the area, discard of data which is stored based on a predetermined rule in the case where the remaining capacity of the storage area satisfies a predetermined condition; and a discard information retaining section that retains discard information indicating a result of the discard performed by the discard section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a relay apparatus according to an embodiment of the present invention;

FIG. 2 is a block diagram illustrating an example of functions of a capture unit;

FIG. 3 is a view illustrating examples of retrieval conditions and retrieval condition expressions retained in a retrieval condition retaining section;

FIG. 4 is a view illustrating a management table that manages capture groups;

FIG. 5 is a view illustrating the proportion among partitioned areas of a data retaining section;

FIG. 6 is a view illustrating movements of a read pointer and a write pointer;

FIG. 7 is a flowchart illustrating capture processing of communication data flowing from a network interface section to a routing section;

FIG. 8 is a flowchart illustrating capture processing of communication data flowing from the routing section to the network interface section;

FIG. 9 is a flowchart illustrating upload processing performed in the case where the routing section has received an upload request from an external management apparatus;

FIG. 10 is a flowchart illustrating internal upload processing performed in the upload section;

FIG. 11 is a flowchart illustrating upload start request processing that the upload section performs for the routing section;

FIG. 12 is a flowchart illustrating routing section side upload processing based on a start request flag;

FIG. 13 is a view illustrating a mode in which capture data is discarded in the order from the oldest; and

FIG. 14 is a view illustrating a mode in which capture data is discarded in the order from the newest.

### DESCRIPTION OF EMBODIMENT

Hereinafter, an embodiment of the present invention will be described with reference to the accompanying drawings.

In a conventional relay apparatus, there may be a case where a capture memory provided in the relay apparatus is full of unnecessary capture data to prevent really-required data from being captured.

Further, although a conventional packet filter can sort out packets using a filtering condition, all the acquired packet is treated the same in the subsequent management process, so that a memory may be full of data that need to be acquired but is less important, which may prevent data of primary importance from being acquired.

Further, in the case where data is discarded due to memory full, information indicating the discard of data is not retained in the conventional packet filter. Therefore, it is impossible for a user to determine whether packet loss is caused due to the memory full or due to influence of network traffic.

The present embodiment has been made to solve the above problems, and an object thereof is to provide a capture apparatus and a capture method that facilitate analysis of capture data by retaining and uploading the capture data in units of a group and retaining data discard information in the case where the capture data is discarded.

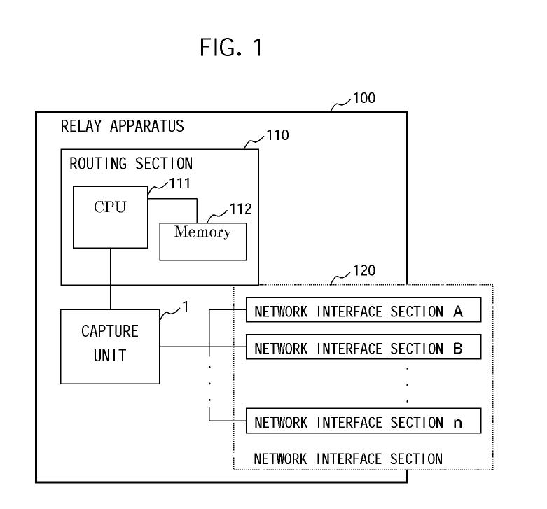

A configuration of a relay apparatus according to the present embodiment will be described with reference to FIG. 1.

A relay apparatus 100 includes a routing section 110, a capture unit 1, and a network interface section 120. Any of network interfaces provided in the network interface section 120 are connected to an external management apparatus for a user to browse, analyze, and store captured data (matching data).

The routing section 110 performs data transfer processing. More specifically, the routing section 110 transmits communication data that the network interface section 120 has received through a given network to another network by way of a best suited path. The routing section 110 includes a CPU (Central Processing Unit) 111 and a memory (storage unit) 112.

The network interface section 120 performs physical input/output of communication data.

The capture unit 1 is provided between the routing section 110 and the network interface section 120 so as to capture communication data flowing between the routing section 110 and network interface section 120 based on a predetermined retrieval condition and a predetermined retrieval condition expression. Further, the capture unit 1 retains the captured communication data (hereinafter, referred to as “capture data”) and uploads the retained capture data to an external management apparatus.

The capture unit 1 according to the present embodiment may be provided inside or outside the relay apparatus.

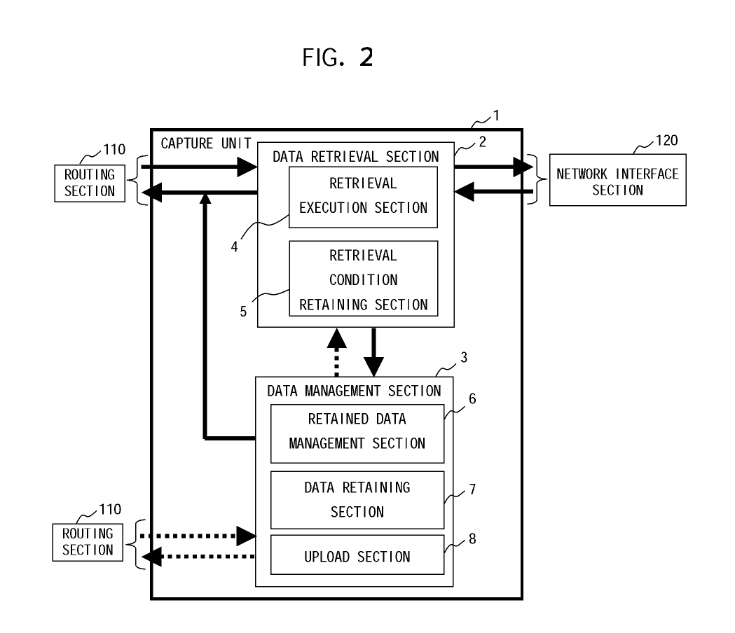

Functions of the capture unit 1 will be described with reference to a functional block diagram of FIG. 2. Solid arrows in FIG. 2 indicate the flow of communication data (or capture data), and broken arrows indicate the flow of control data. Capture unit 1 has CPU and a memory. The CPU executes the program maintained beforehand in the memory and each section in capture unit 1 is achieved. Each section in capture unit 1 may be achieved by the hardware resource of CPU 111 and memory 112 being used.

The capture unit 1 includes a data retrieval section 2 and a data management section 3. The data retrieval section 2 is connected to the data management section 3, the routing section 110, and the network interface section 120 and retrieves communication data sending from the routing section 110 or network interface section 120. Further, the data retrieval section 2 includes a retrieval execution section 4 and a retrieval condition retaining section 5.

The retrieval condition retaining section 5 receives a plurality of retrieval conditions that are registered therein with the bit string of communication data to be captured as a retrieval condition and retains the plurality of retrieval conditions. Further, the retrieval condition retaining section 5 combines the registered retrieval conditions to group the retrieval conditions as retrieval condition expressions.

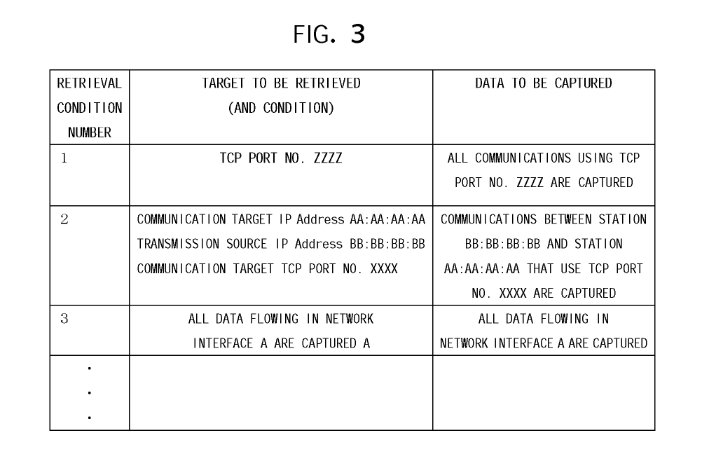

Examples of the retrieval conditions and retrieval condition expressions retained in the retrieval condition retaining section 5 are illustrated in FIG. 3. The retrieval condition expression is managed as a retrieval condition number. For example, in retrieval condition number 1, a predetermined TCP port number is set as a retrieval condition expression. In retrieval condition number 2, retrieval conditions concerning respectively a communication target IP address, a transmission source IP address, and a predetermined TCP port number of the communication target are grouped with an AND condition. In retrieval condition number 3, network interface A is represented as a retrieval condition expression, defining that all communication data flowing in the network A are captured. In retrieval condition numbers 1 and 3, only one retrieval condition exists, so that the retrieval condition expression corresponds to the retrieval condition.

As described above, a plurality of retrieval conditions are registered, and the retrieval conditions are grouped as one retrieval condition expression like the retrieval condition number 2, allowing discrimination of communication data in units a data group, and further allowing the plurality of retrieval conditions to be combined. In addition to retrievals under the above retrieval conditions, a retrieval may be performed with only reception or transmission data flowing in each network interface set as the data to be retrieved or depending on discrimination result of the content of communication data.

The retrieval execution section 4 has a function of retrieving the content of communication data. More specifically, the retrieval execution section 4 compares the retrieval condition expression retained by the retrieval condition retaining section 5 and communication data to distinguish data to be captured from data not to be captured to thereby acquire capture data (matching data) matched with the retrieval condition expression. At the same time, the retrieval execution section 4 acquires control information such as time for acquiring capture data, packet length of capture data, and discard information (to be described later).

As described above, the functions of the retrieval execution section 4 and retrieval condition retaining section 5 of the data retrieval section 2 are used to retrieve the communication data flowing between the routing section 110 and network interface section 120, thereby allowing the communication data matched with the retrieval condition expression to be determined as capture data and the determination result to be notified to the data management section 3.

The data management section 3 is connected to the routing section 110 and the data retrieval section 2 and manages the capture data captured by the data retrieval section 2. The data management section 3 includes a retained data management section 6, data retaining section 7, and upload section 8.

The retained data management section 6 retains capture data captured by the retrieval execution section 4 in a capture memory incorporated in the data retaining section 7. Further, the retained data management section 6 divides the storage area of the capture memory into a plurality of partitions and manages each partitioned area.

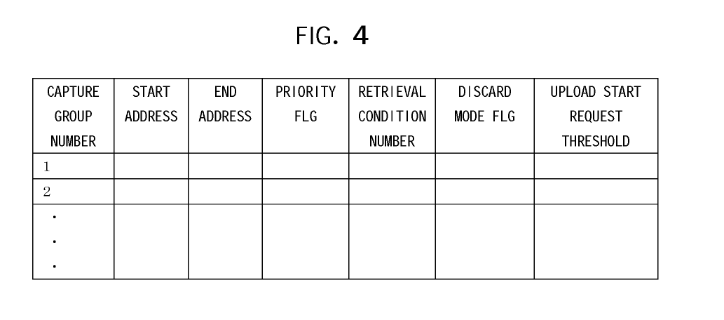

The retained data management section 6 forms a group called “capture group” so as to manage the capture data. The details of the capture group will be described below with reference to a management table (set) for managing the capture group of FIG. 4. Each capture group has, as main items, identification number (capture group number) which is used for identifying the capture data, start and end addresses (position data) of the capture data on the capture memory which is used for managing the capture data, and retrieval condition number (a plurality of retrieval condition numbers can be registered, and registered retrieval condition numbers are linked with an OR condition) (condition) retained by the retrieval condition retaining section 5. The range defined by the start and end addresses on the capture memory corresponds to each partitioned area of the capture group.

The retained data management section 6 manages the capture group in which the retrieval condition number and partitioned area are associated with each other to thereby retain the capture data retrieved by the retrieval execution section 4 in the corresponding partitioned area. That is, a correspondence between the retrieval condition expression used at the time of a retrieval performed by the retrieval execution section 4 and partitioned area is derived from a correspondence (FIG. 3) between the retrieval condition expression used at the time of a retrieval performed by the retrieval execution section 4 and retrieval condition number and correspondence (management table illustrated in FIG. 4) between the retrieval condition number and partitioned area, allowing the capture data retrieved by the retrieval condition expression to be retained in the corresponding partitioned area.

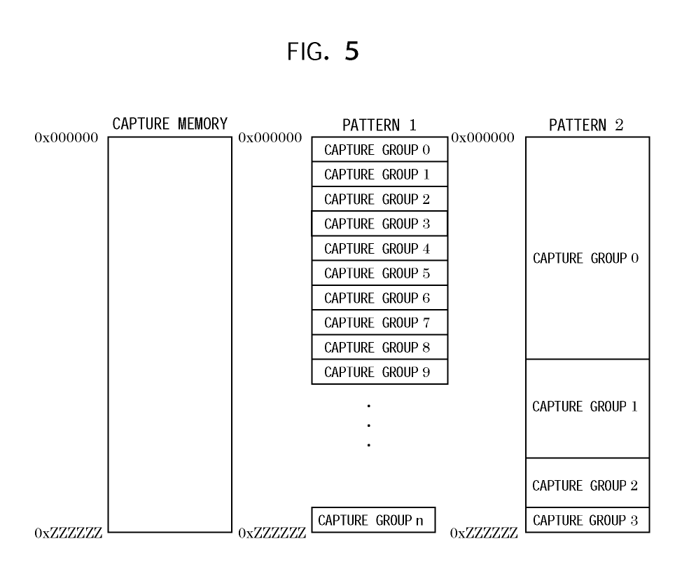

In the case where the start or end address of each capture group is changed, the retained data management section 6 can instruct the data retaining section 7 to change the proportion among the partitioned areas of the capture group as illustrated in FIG. 5. For example, the retained data management section 6 may divide the entire storage area into a plurality of portioned areas of the capture groups in the same proportion as pattern 1 of FIG. 5. Alternatively, in the case where, for example, capture group 0 has data of high importance and data of large amount, the retained data management section 6 may increase the proportion of the portioned area corresponding to the capture group 0 as pattern 2 of FIG. 5.

As described above, the retained data management section 6 can change the proportion among the partitioned areas depending on the condition, allowing a user to perform data management according to the attribute of data to be retained, estimated data amount, and degree of urgency.

In addition to the above items, each capture group has the following items: flag (priority FLG) for the routing section 110 to preferentially execute capture data upload processing (transmission processing) from normal transfer processing; flag (discard mode FLG) for determining a mode of discarding the capture data; and threshold (upload start request threshold) used for issuing an upload start request when the storage area is about to be full of capture data. The details of these items will be described later.

The retained data management section 6 further has a function of writing control information while associating one by one the control information with capture data.

The data retaining section 7 is a real memory (capture memory), which stores capture data and corresponding control information under the management of the retained data management section 6.

The upload section 8 transfers the capture data and corresponding control information retained in the data retaining section 7 in units of each partitioned area to an external management apparatus under the control of the routing section 110. Further, the upload section 8 controls a read pointer and a write pointer to be described later.

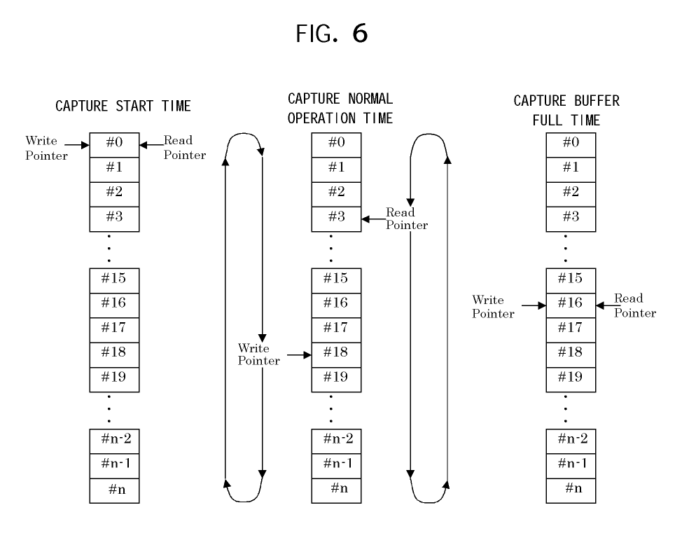

Here, with reference to FIG. 6, management of the partitioned areas will be described concerning input of the capture data to each partitioned area by the retained data management section 6 and output of the capture data from each partitioned area by the upload section 8.

FIG. 6 illustrates three use states (capture start time, capture normal operation time, and capture buffer full time) of the capture memory in one partitioned area. In FIG. 6, #0, #1, . . . #n denote addresses at which the capture data and corresponding control information are stored. The upload section 8 manages input processing that the retained data management section 6 performs for each partitioned area and output processing that the upload section 8 performs for each partitioned area by using a write pointer (storage position information) and a read pointer (transmission position information).

At the time immediately after power-on of the relay apparatus 100, no data exists in the capture memory, and both the write pointer and read pointer specify a storage area of #0 (see “capture start time” of FIG. 6).

When the retained data management section 6 performs data writing, the data is written into an address specified by the write pointer, and the write pointer moves to the next address by an amount corresponding to the sizes of one piece of capture data and one piece of control information. When the upload section 8 performs output processing, data at an address specified by the read pointer is read, and the read pointer moves to the next address by an amount corresponding to the sizes of one piece of capture data and one piece of control information.

In the example of “capture normal operation time” of FIG. 6, the retained data management section 6 writes data at an address of #18, and the upload section 8 reads data at an address of #3. Each partitioned area is a ring buffer, so that when the write pointer (or read pointer) reaches the ending address (#n), the write pointer (or read pointer) moves to the starting address (#0) for the capture data and corresponding control information to be written in the next processing cycle.

In the case where the storage area has become full of the capture data, the read pointer and write pointer specify the same address as illustrated in “capture buffer full time” of FIG. 6.

A positional difference corresponding to one data occurs in the address position of the write pointer by after completion of the writing processing performed by the retained data management section 6 between cases where the write pointer is moved after completion of the writing processing and where data is written after movement of the write pointer. The same can be said for the readout processing of the upload section 8.

The processing performed in the present embodiment will be described with reference to a flowchart. The processing in the present embodiment can be divided into capture processing and upload processing.

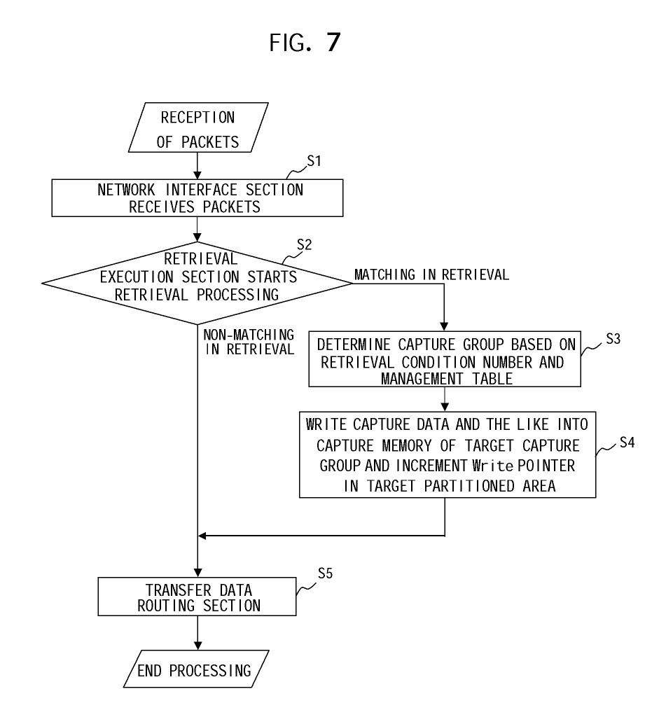

First, the capture processing will be described. A flow of processing that captures communication data flowing from the network interface section 120 to the routing section 110 is illustrated in a flowchart of FIG. 7.

When the network interface section 120 receives communication data from outside (step S1), the retrieval execution section 4 retrieves the communication data based on predetermined retrieval condition expressions (step S2). In the case where the communication data is matched with any of the retrieval condition expressions (matching in retrieval in step S2), the retrieval execution section 4 outputs the retrieval condition number of the retrieval condition expression with which the communication data is matched and captured communication data (capture data) to the retained data management section 6.

The retrieval execution section 4 acquires the current time, sets a value (this operation is not discard operation, so that a value of 0 is set) for calculation of the length of the capture data and to the discard information as the control information, and outputs the control information to the retained data management section 6 together with the capture data.

The retained data management section 6 determines a target capture group based on the retrieval condition number acquired from the retrieval execution section 4 and management table (FIG. 4) (step S3) and writes the capture data and corresponding control information into an address specified by the write pointer in the partitioned area corresponding to the target capture group. Thereafter, the upload section 8 adds values corresponding to one piece of capture data and one piece of control information to the write pointer in the partitioned area to which the capture data has been written to thereby move the address specified by the write pointer by an amount corresponding to the sizes of one piece of capture data and one piece of control information (step S4).

Although a value corresponding to the size of one capture group is added to the write pointer in the partitioned area by the upload section 8 in the present embodiment, this addition may be made by the retained data management section 6. Further, although the write pointer is moved by the upload section 8 after the writing of the captured data performed by the retained data management section 6 in the present embodiment, the write pointer may be moved by the upload section 8 before the writing of the captured data performed by the retained data management section 6.

After that, the communication data is transferred to the routing section 110 (step S5), and traditional transfer processing is then performed.

On the other hand, in the case where the communication data is not matched with any of the retrieval condition expressions in the retrieval processing performed by the retrieval execution section 4 (non-matching in retrieval in step S2), the communication data is directly transferred to the routing section 110 (step S5), and traditional communication data relay processing is then performed.

With a repetition of the above operations, the packet capture can be achieved.

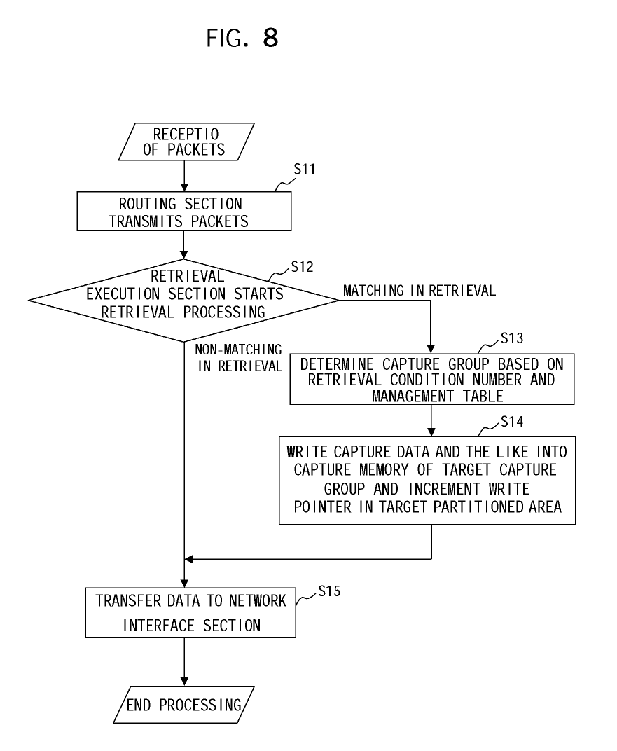

Further, a case where the routing section 110 itself generates network packets (communication data) and transmits the network packets and information of the routing section 110 itself to outside via the network interface section 120 can be considered, and such communication data can be a capture target. The processing in such as case will be described with reference to a flowchart of FIG. 8 illustrating a flow of processing that captures communication data flowing from the routing section 110 to the network interface section 120.

The routing section 110 transmits communication data directed to the network interface section 120 (step S11), and the retrieval execution section 4 performs the retrieval processing (step S12). In the case where the communication data is matched with any of the retrieval condition expressions (matching in retrieval in step S12) in the retrieval processing performed by the retrieval execution section 4, the abovementioned processing of determining a capture group and writing the capture data are performed (step S13 and step S14). After that, the communication data is transferred to the network interface section 120 (step S15), and the transferred data is then transmitted to outside. The processing of step S12 to S14 is the same as the processing of step S2 to S4.

On the other hand, in the case where the communication data is not matched with any of the retrieval condition expressions in the retrieval processing performed by the retrieval execution section 4 (non-matching in retrieval in step S12), the communication data is directly transferred to the network interface section 120 (step S15), and the transferred data is then transmitted to outside.

When the capture data is accumulated in the partitioned areas of the data retaining section 7 through the above processing, the storage area may become full of the capture data. Therefore, readout (upload) processing of the capture data is performed to transfer the capture data to an external management apparatus in order to delete the capture data in the partitioned area.

The type of the upload processing will be described. The type of the upload processing includes upload processing (external upload processing) in which the routing section 110 uploads the capture data to an external management apparatus and upload processing (internal upload processing) in which the upload section 8 uploads the capture data to the routing section 110. The upload processing is started when an upload request is issued from the external management apparatus to the routing section 110 or when an upload request is issued from the upload section 8 to the routing section 110, irrespective of the above type of the upload processing.

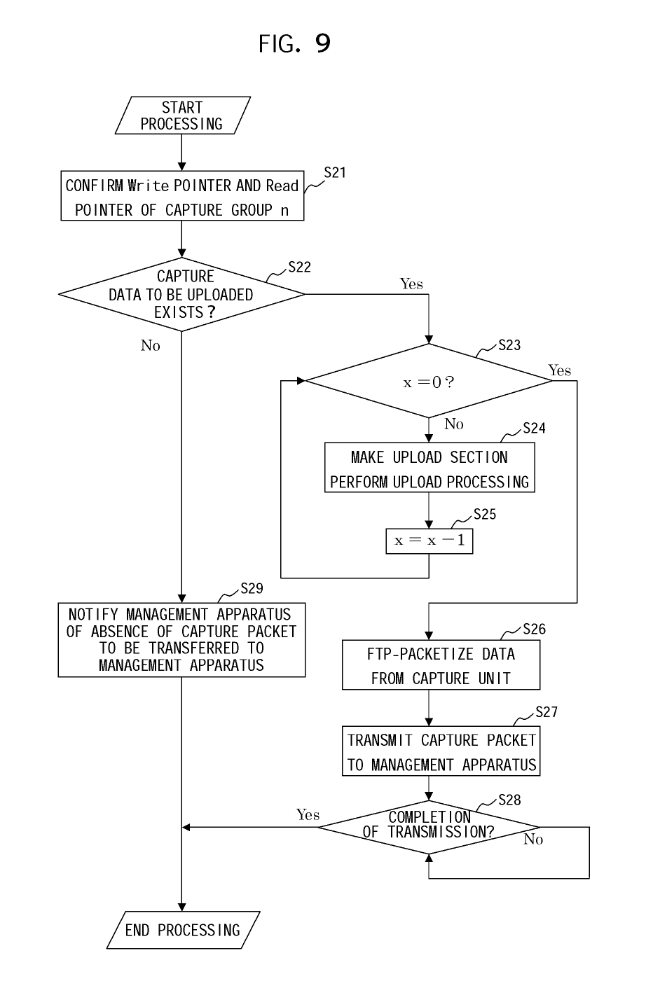

With reference to a flowchart of FIG. 9, upload processing performed in the case where the routing section 110 has received an upload request from an external management apparatus will be described. Although the routing section 110 can specify the number of pieces of capture data (or all the capture data) to be uploaded as appropriate, it is assumed that x pieces of capture data are uploaded from a partitioned area corresponding to capture group n in the present embodiment. Although steps other than step S24 in the processing flow illustrated in FIG. 9 are executed by software running on the routing section 110, they may be executed by the upload section 8.

Upon receiving the upload request, the routing section 110 confirms the write pointer and read pointer in the partitioned area corresponding to the capture group n stored in the data retaining section 7 (step S21) to determine presence/absence of capture data to be uploaded (step S22). In the case where there exists any capture data to be uploaded (Yes in step S22), the routing section 110 determines whether x is 0 (step S23). In the case where x is not 0 (No in step S23), the routing section 110 makes the upload section 8 perform the internal upload processing (to be described later) so as to acquire the capture data (step S24).

After completion of the internal upload processing, the routing section 110 decrements x by 1 (step S25) and returns the processing to the determination processing of step S23. The processing of steps S24 and S25 is repeated until x becomes 0. At the time point when x has become 0 (Yes in step S23), the routing section 110 FTP-packetizes x pieces of capture data and corresponding control information acquired in step S24 (step S26) and transmits the packetized capture data to the external management apparatus using an FTP protocol (step S27, step S28).

After completion of the transmission of the capture data to the external management apparatus (Yes in step S28), the processing is ended.

In the case where there exists no capture data to be uploaded (No in step S22), the routing section 110 notifies the external management apparatus of absence of the capture data to be transferred (step S29).

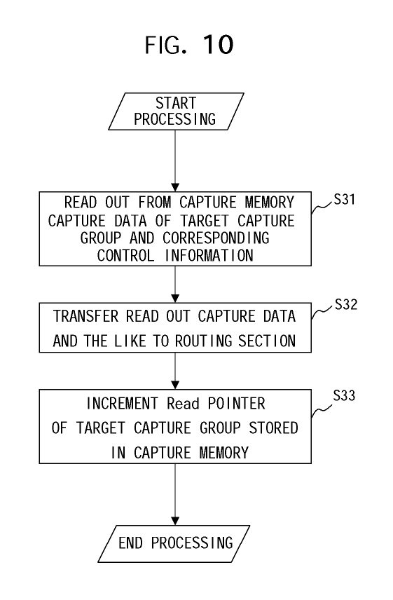

The internal upload processing performed by the upload section 8 will be described with reference to a flowchart of FIG. 10. The following internal upload processing corresponds to step S24 of FIG. 9.

The upload section 8 reads out one piece of capture data and corresponding control information stored in a partitioned area corresponding to capture group n (step S31). Here, the upload section 8 reads out the capture data and corresponding control information from an address specified by the read pointer at the current position. After that, the upload section 8 transfers the read out capture data and corresponding control information to the routing section 110 (step S32) and adds a value corresponding to the sizes of one piece of capture data and one piece of control information to the read pointer in the partitioned area corresponding to capture group n stored in the data retaining section 7 (step S33).

Although the upload section 8 increments the read pointer after reading out the data, it may read out the data after incrementing the read pointer.

The normal upload processing is performed in the case where the routing section 110 has received an upload request from an external management apparatus as described above. However, in the case where a state in which the upload request from the external management apparatus is not issued continues for some reason to cause a difference between the write pointer and the read pointer managed by the upload section 8 to fall below an upload threshold (upload start request threshold recorded on the management table illustrated in FIG. 4), the upload section 8 issues an upload start request to the routing section 110 in order not to prevent a target capture group from being written in the corresponding partitioned area.

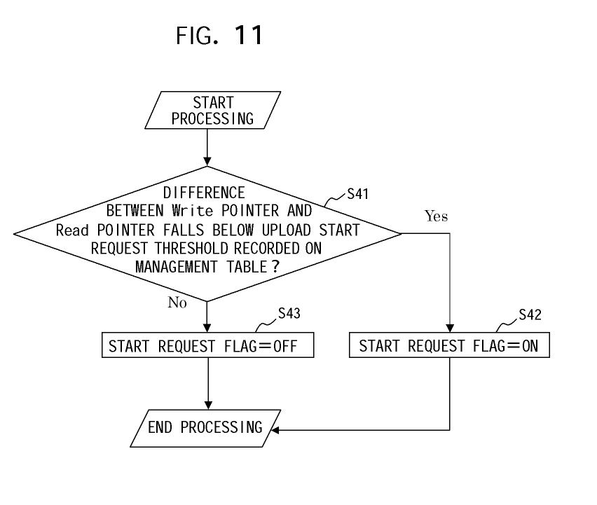

The above upload processing is started with upload start request processing that the upload section 8 performs for the routing section 110 as a trigger. FIG. 11 is a flowchart illustrating the upload start request processing.

The upload section 8 confirms a difference between the write pointer and the read pointer in a partitioned area corresponding to a predetermined capture group (capture group n as in the above example) to determine whether the difference falls below an upload start request threshold (predetermined threshold) recorded with reference to the management table (see FIG. 4) (step S41). In the case where the difference falls below the upload start request threshold (Yes in step S41), the upload section 8 turns ON a start request flag to make an upload start request to the routing section 110 (step S42). In the case where the difference does not fall below the upload start request threshold (No in step S41), the upload section 8 turns OFF the start request flag to stop the upload start request (step S43). Although ON/OFF of the start request flag is retained and managed in the routing section 110, it may be retained and managed in the upload section 8.

The upload start request processing of the upload section 8 is performed on an as needed basis.

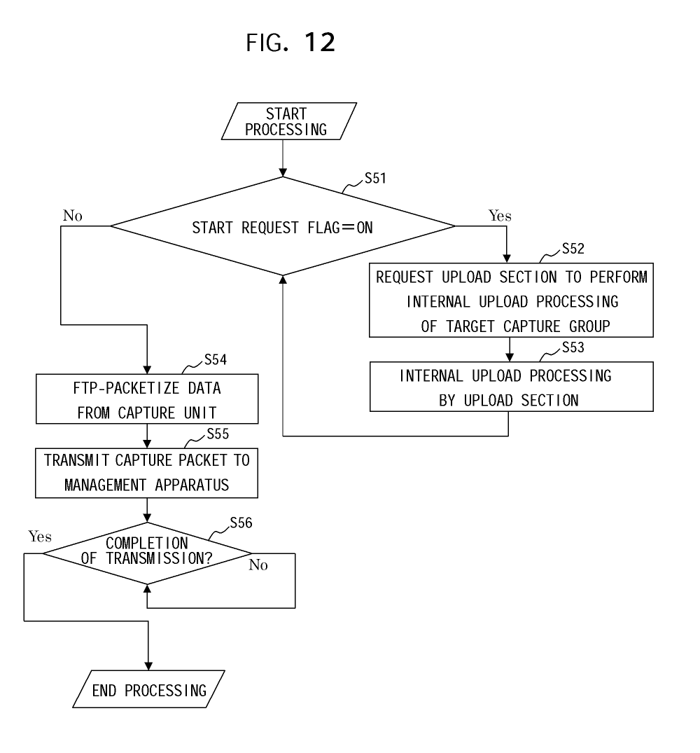

The upload processing of the routing section 110 which is performed based on the start request flag as described above will be described with reference to FIG. 12. The routing section 110 switches from the currently processing task to upload start request processing of the upload section 8, thereby starting the upload processing.

The routing section 110 confirms whether the start request flag is ON (step S51). In the case where the start request flag is ON (Yes in step S51), the routing section 110 requests the upload section 8 to perform the internal upload processing for the partitioned area corresponding to a target capture group (capture group n) (step S52). Upon receiving the request, the upload section 8 performs the internal upload processing (step S53). Since the content of the internal upload processing is the same as the processing described in FIG. 10, the description thereof will be omitted.

After completion of the internal upload processing, the routing section 110 confirms once again whether the start request flag is ON (step S51). As described above, the processing from step S51 to S53 is repeated until the start request flag is turned OFF.

In the case where a difference between the write pointer and the read pointer in the partitioned area corresponding to capture group n has become equal to or exceeded the upload start request threshold (No in step S41 of FIG. 11) to turn OFF the upload start request flag (step S43 of FIG. 11, No in step S51), the routing section 110 FTP-packetizes the capture data (capture data accumulated by the processing of step S53 which is performed during a start request flag ON state) from the capture unit (upload section 8) and corresponding control information (step S54) and transmits the packetized data to an external management apparatus using an FTP protocol (step S55 and step S56).

After completion of the transmission of the capture data to the external management apparatus (Yes in step S56), the processing is ended.

With the above upload start request processing that the upload section 8 performs for the routing section 110, it is possible to perform data capture without discarding capture data from the partitioned area.

However, in the case where a large volume of upload packets to be captured in the relay apparatus 100 flow on a transmission path, it take much time to perform memory read for upload with the result that memory write for capture data retention is started before the memory read has been completed. This may cause the target partitioned area to be full (predetermined condition), and discard of the capture data of the target captured group becomes needed.

Here, a discard mode (predetermined rule) will be described. The discard mode is divided into modes: one is a mode in which capture data or its corresponding control information retained in each partitioned area are discarded in chronological order (in the order from the oldest to newest), and one is a mode in which they are discarded in reverse chronological order (in the order from the newest to oldest). The retained data management section 6 uses a discard mode FLG (see FIG. 4) recorded on the management table to allow a user to adopt which of the two discard modes for each capture group.

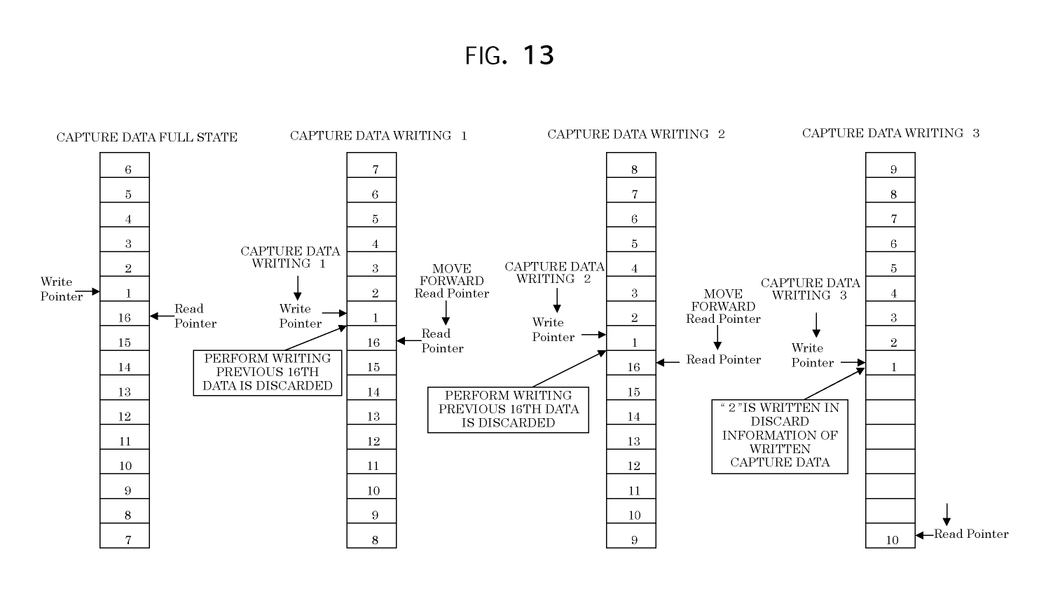

The discard mode in which data is discarded in the order from the oldest will be described with reference to FIG. 13. It is assumed here that the capacity of the memory area corresponds to 16 sets of the capture data and control information and that the smaller the number is, the newer the data is.

A state where the memory area is full is illustrated in “capture data full state” of FIG. 13. In the case where the retained data management section 6 needs to write data in this state, the retained data management section 6 writes the newest data into the address at which the oldest data (16th data in “capture data full state” of FIG. 13) is stored to thereby discard the oldest data. Then, the upload section 8 adds 1 to a discard counter managed therein to move forward the read pointer by an amount corresponding to the sizes of the discarded capture data and corresponding control information (i.e., one piece of capture data and one piece of control information).

The above processing is performed every time the retained data management section 6 performs data writing.

A state where one piece of data is discarded from the memory area of “capture data full state” is illustrated in “capture data writing 1” of FIG. 13, and a state where two pieces of data are discarded from the memory area of “capture data full state” is illustrated in “capture data writing 2” of FIG. 13.

At the time point when the relay apparatus 100 has escaped a congestion state and upload of the capture data and corresponding control information is started, a sufficient room is provided between the read pointer and the write pointer. In the case where writing of the capture data and the like by the retained data management section 6 occurs in this state, the upload section 8 writes the number (in this example, “2”) of discarded packets counted by the discard counter in the discard information in the control information corresponding to the written capture data and shifts to normal capture operation (see “capture data writing 3” of FIG. 13).

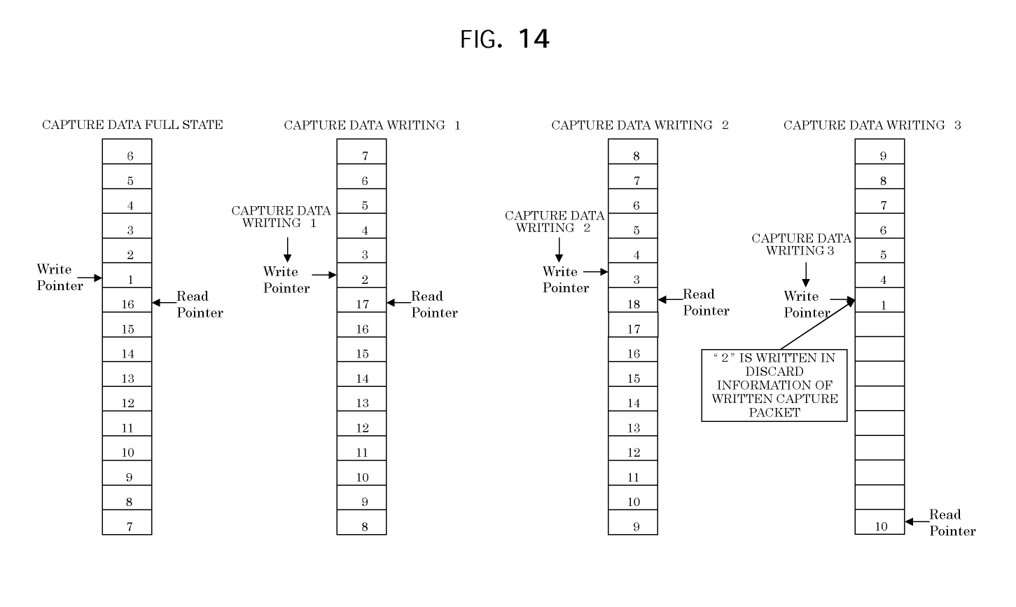

The discard mode in which data is discarded in the order from the newest will be described with reference to FIG. 14. FIG. 14 illustrates operations in four states (capture data full state, capture data writing 1, capture data writing 2, and capture data writing 3). As in the above case, it is assumed here that the capacity of the memory area corresponds to 16 sets of the capture data and control information and that the smaller the number is, the newer the data is.

A state where the memory area is full is illustrated in “capture data full state” of FIG. 14. In this state, the retained data management section 6 does not write the newest capture data and corresponding control information (thus, the newest data is discarded). While the newest data are not written and discarded, the upload section 8 increments the discard counter managed therein by the number of the discarded packets.

A state where one piece of data is discarded from the memory area of “capture data full state” is illustrated in “capture data writing 1” of FIG. 14, and a state where two pieces of data are discarded from the memory area of “capture data full state” is illustrated in “capture data writing 2” of FIG. 14.

At the time point when the relay apparatus 100 has escaped a congestion state and upload of the capture data and corresponding control information is started, a sufficient room is provided between the read pointer and the write pointer. In the case where writing of the capture data and corresponding control information occurs in this state, the upload section 8 writes the number indicated by the discard counter in the discard information in the control information corresponding to the written capture data and shifts to normal capture operation (see “capture data writing 3” of FIG. 14).

Although the management of the discard counter and writing into the discard information are performed by the upload section 8 in both the mode in which data is discarded in the order from the oldest and mode in which data is discarded in the order from the newest, they may be performed by the retained data management section 6.

Further, although the above discard modes are applied to the memory area divided into a plurality of partitioned areas in the present embodiment, they may be applied to any storage medium as long as it has a limited storage area.

Thus, irrespective of whether the mode in which the data is discarded in the order from the oldest or mode in which the data is discarded in the order from the newest is adopted, a user can confirm that data discard processing has previously been made in the capture unit 1 when analyzing the packets using an external management apparatus by referring to the discard information of the control information of uploaded data.

Further, a user can perform operation in accordance with the characteristics of data to be captured by selecting the data discard mode for each capture group.

The following point can be further taken as a factor that causes the memory area to be full. That is, the routing section 110 gives preference to transfer processing which is the original function over the capture data upload processing, which may cause the data to remain accumulated in the memory area. In the following, a method in which discard of the packets captured at the congestion time is prevented by allowing the routing section 110 to give preference to the capture data upload processing over relay data transfer processing.

In this method, the priority FLG (see FIG. 4) of the management table is used to give preference to the upload processing over the relay processing, allowing the CPU 11 that has received an upload processing request to stop the transfer processing of relay data. With this method, even when a large volume of packets to be captured flow in a transmission path to cause a large number of write requests of packets into respective partitioned areas, the relay apparatus 100 preferentially performs the capture data upload processing, thereby preventing the write pointer from overtaking the read pointer.

Thus, it is possible to guarantee the identity between the relayed data and capture data while preventing the capture data that has once been captured from being discarded. Further, it is possible to preferentially perform upload processing of important capture group.

As described above, unlike a general capture relay apparatus, the relay apparatus according to the present embodiment can group the retrieval conditions as a retrieval condition expression and can retain and upload data in/to partitioned areas in units of the group. Thus, when analyzing the capture data using an external management apparatus, a user can analyze only a target capture data group.

A retaining section corresponds to the retrieval condition retaining section 5 and retained data management section 6 in the embodiment, an acquisition section corresponds to the retrieval execution section 4 in the embodiment. A storage section corresponds to the retained data management section 6 and data retaining section 7 in the embodiment. A transmission section corresponds to the upload section 8 in the embodiment. A discard section corresponds to the retained data management section 6 in the embodiment, and a discard information retaining section corresponds to the upload section 8 or retained data management section 6 in the embodiment.

As described above, according to the present invention, a user can easily analyze the capture data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A capture apparatus that can be connected to at least one communication path and captures communication data passing through the communication path and stores the communication data in a storage medium, comprising:
a retaining section that retains at least one set of position information of an area set to the storage medium and the condition of the communication data stored in the area;
an acquisition section that captures communication data matched with the condition retained by the retaining section out of the communication data passing through the communication path as matching data; and
a storage section that captures the position information of the storage area which is an area corresponding to the condition matched with the matching data and stores at least the matching data in the storage area.

2. The capture apparatus according to claim 1, comprising a transmission section that performs transmission processing of transmitting data stored in the area to an external device.

3. The capture apparatus according to claim 2, wherein
the transmission section sets a storage position at which the matching data is stored on a per area basis,
the storage section stores at least the matching data in the storage position and moves the storage position by an amount corresponding to the size of the stored data, and
the transmission section sets a transmission position at which the matching data is transmitted, transmits the data stored in the transmission position, and moves the transmission position by an amount corresponding to the size of the transmitted data.

4. The capture apparatus according to claim 3, wherein
the area is a ring buffer, and
the storage position and transmission position move on the ring buffer.

5. The capture apparatus according to claim 4, wherein
in the case where a difference between the storage position and transmission position has become not more than a predetermined threshold, the transmission section transmits the matching data to an external device.

6. The capture apparatus according to claim 1, wherein when storing the matching data in the storage area, the storage section performs data discard based on a predetermined rule in the case where the remaining capacity of the storage area satisfies a predetermined condition.

7. The capture apparatus according to claim 6, wherein
the storage section stores information concerning a result of the data discard as discard information.

8. The capture apparatus according to claim 6, wherein
the predetermined rule is a rule under which the matching data is discarded when the matching data is stored.

9. The capture apparatus according to claim 6, wherein
the predetermined rule is a rule under which the oldest data among the data stored in the area storing the matching data is discarded when the matching data is stored.

10. The capture apparatus according to claim 6, wherein
the retaining section retains the predetermined rule on a per area basis, and
the storage section acquires the rule corresponding to the storage area from the retaining section and performs the data discard according to the acquired rule.

11. The capture apparatus according to claim 2, wherein
the transmission section performs relay processing on the communication path,
the retaining section retains the priority of the transmission processing over the relay processing on a per area basis, and
the transmission section performs the relay processing and transmission processing according to the priority.

12. A capture apparatus that can be connected to at least one communication path and captures communication data passing through the communication path and stores the communication data in a storage medium, comprising:
an acquisition section that captures communication data matched with set condition out of the communication data passing through the communication path as matching data;
a storage section that stores the matching data in an area set to the storage medium;
a discard section that performs, when the storage section stores the matching data in the area, discard of data which is stored based on a predetermined rule in the case where the remaining capacity of the storage area satisfies a predetermined condition; and
a discard information retaining section that retains discard information indicating a result of the discard performed by the discard section.

13. The capture apparatus according to claim 12, wherein
the predetermined rule is a rule under which the matching data is discarded when the storage section stores the matching data.

14. The capture apparatus according to claim 12, wherein
the predetermined rule is a rule under which the oldest data among the data stored in the area storing the matching data is discarded when the storage section stores the matching data.

15. The capture apparatus according to claim 12, comprising a retaining section that retains the predetermined rule,
the storage section acquiring the rule from the retaining section and performing the data discard according to the acquired rule.

16. The capture apparatus according to claim 12, wherein
the discard information retaining section retains the number of data discarded by the discarded section as discard information.

17. A capture method that captures communication data passing through the communication path and stores the communication data in a storage medium, the method comprising:
acquiring a set of position information of an area set to the storage medium and the condition of the communication data stored in the area;
capturing communication data matched with the acquiring condition out of the communication data passing through the communication path as matching data; and
capturing the position information of the storage area which is an area corresponding to the condition matched with the matching data; and
storing at least the matching data in the storage area.

18. The capture method according to claim 17, further comprising transmitting data stored in the area to an external device.

19. The capture method according to claim 18, further comprising:
setting a storage position at which the matching data is stored on a per area basis,
storing at least the matching data in the storage position and moving the storage position by an amount corresponding to the size of the stored data, and
setting a transmission position at which the matching data is transmitted, transmitting the data stored in the transmission position to an external device, and moving the transmission position by an amount corresponding to the size of the transmitted data.

20. The capture method according to claim 17, comprising, when the matching data is stored in the storage area, performing data discard based on a predetermined rule in the case where the remaining capacity of the storage area satisfies a predetermined condition.
